(19) United States
(12) Patent Application Publication
(10) Pub. No.: US 2008/0292786 A1
(43) Pub. Date: Nov. 27, 2008

(54) Method of manufacturing display device

(75) Inventors: Mutsuko Hatano, Kokubunji (JP); Takashi Hattori, Musashimurayama (JP)

Correspondence Address: REED SMITH LLP;Suite 1400, 3110 Fairview Park Drive, Falls Church, VA, 22042, US

(73) Assignee: Hitachi Displays, Ltd.

(21) Appl. No.: 12/153,568

(22) Filed: May 21, 2008

(30) Foreign Application Priority Data
May 23, 2007 (JP) 2007-136139

(51) Int. Cl. B05D 5/06

(52) U.S. Cl. 427/162

(57) ABSTRACT

Provided is a method of manufacturing a display device having a step of forming a resin material layer by curing a resin coated on the main surface of a glass substrate; a step of forming a display circuit configured by a plurality of lamination material layers on the main surface side of said resin material layer; and a step of generating exfoliation at the interface between said resin material layer and said glass substrate, by irradiating a ultraviolet ray from the surface on the opposite side to the surface provided with said display circuit of said glass substrate, and said resin material layer, from which said glass substrate is removed, is used as a substrate provided with said display circuit.

### INCORPORATION BY REFERENCE

The present application claims priority from Japanese application JP007-136139 filed on May 23, 2007, the content of which is hereby incorporated by reference into this application.

### BACKGROUND OF THE INVENTION

The present invention relates to a method of manufacturing a display device, in particular, relates to a method of manufacturing a display device provided with a substrate of a flexible material composed of a resin material.

In recent year, there has been known, as a display device, one using a substrate (hereafter may be referred to as a plastic film) of a flexible material composed of a resin material, instead of a conventional glass substrate.

In the case where a plastic film is used as a substrate in this way, an extremely lighter weight and thinner-type display device can be configured, as compared with one using a glass substrate.

However, such a display device inevitably requires to pass through a step, in manufacturing thereof, to discard the glass substrate, after forming a pixel drive element configured by a thin film transistor, which is a micro-patterned laminated layer configured by an electric conductive layer, a semiconductor layer, or an insulating layer or the like, formed in predetermined patterns by, for example, photolithography technology on the upper surface of the glass substrate, which is a tentative substrate, and further, forming all of or a part of drive circuits (display circuits), and then after exfoliating the laminated layer from the glass substrate and transferring the laminated layer onto a newly prepared plastic film.

The reason why is that, in order to form each of the electric conductive layer, semiconductor layer and insulating layer or the like in good reliability, by highly precise positioning, it is suitable to form them on the upper surface of a heat resistant glass substrate having rigidity. In other words, a plastic film, because of having low rigidity and low heat deformation temperature, is easily suffered from heat deformation such as warpage or expansion-shrinkage, in a manufacturing step accompanying heat treatment, and it is difficult to form, in good reliability, a laminated layer of the electric conductive layer, the semiconductor layer and the insulating layer or the like, configured by predetermined patterns, on the upper surface of the plastic film.

It should be noted that there has been disclosed technology for manufacturing a display device by transferring the laminated layer of the electric conductive layer, the semiconductor layer and the insulating layer or the like, formed on the glass substrate, onto the plastic film, for example, in JP-A-10-125929.

### SUMMARY OF THE INVENTION

However, it has been pointed out that the above manufacturing method of a display device inevitably required to pass through a plurality of transfer steps, which not only increased manufacturing cost but also reduced yield.

Accordingly, it has been desired to make it possible to manufacture in low cost by a simple configuration, and that to make possible application of an existing manufacturing line as it is.

It is an object of the present invention to provide a method of manufacturing a display device, which makes it possible to manufacture in low cost by a simple configuration.

It is other object of the present invention to provide a method of manufacturing a display device, which makes it possible to manufacture by application of an existing manufacturing line as it is.

Explanation will be given below briefly on outlines of typical ones among embodiments disclosed by the present application, as follows.

(1) A method of manufacturing a display device according to the present invention is characterized by, for example, having: a step of forming a resin material layer by curing a resin coated on the main surface of a glass substrate; a step of forming a plurality of lamination material layers configuring a display circuit on the main surface side of the resin material layer; and a step of exfoliating at the interface between the resin material layer and the glass substrate by irradiating a light from the surface on the opposite side to the surface provided with the lamination material layer of the glass substrate, thereby using the resin material layer, from which the glass substrate is removed, as a substrate provided with the display circuit.

(2) A method of manufacturing a display device according to the present invention is characterized in that, for example, on the premise of a configuration of (1), the resin material layer is composed of a material having an imide ring structure in the main chain.

(3) A method of manufacturing a display device according to the present invention is characterized in that, for example, on the premise of a configuration of (1), the display circuit formed on the main surface side of the resin material layer, is formed by intervention of a barrier layer to avoid intrusion of water or oxygen from the resin material layer side.

(4) A method of manufacturing a display device according to the present invention is characterized in that, for example, on the premise of a configuration of (3), the barrier layer is composed of a laminated layer of any of a silicon oxynitride film, a silicon oxide film, a silicon nitride film, a polysilazane film and an organic material film, or a combination thereof.

(5) A method of manufacturing a display device according to the present invention is characterized in that, for example, on the premise of a configuration of (1), the display circuit is a circuit provided with a thin film transistor.

(6) A method of manufacturing a display device according to the present invention is characterized in that, for example, on the premise of a configuration of (1), a polarizing plate is provided as one of each lamination material layer configuring the display circuit.

(7) A method of manufacturing a display device according to the present invention is characterized by, for example, having:

a step of sequentially forming a first resin material layer and a second resin material layer, having larger light transmittance than that of the first resin material layer, by curing a resin coated on the main surface of a glass substrate; a step of forming a display circuit configured by a plurality of lamination material layers on the main surface side of the second resin material layer; and a step of exfoliating at the interface between the first resin material layer and the second resin material layer, or in first resin material layer, by irradiating a light from the surface on the opposite side to the surface provided with the display circuit of the glass substrate, thereby using the second resin material layer, from which the glass substrate deposited with the first resin material layer is removed, as a substrate provided with the display circuit.

(8) A method of manufacturing a display device according to the present invention is characterized in that, for example, on the premise of a configuration of (6), at least either of the first resin material layer and the second resin material layer is composed of a material having an imide ring structure in the main chain.

(9) A method of manufacturing a display device according to the present invention is characterized by, for example, having: a step of sequentially forming an electric conductive film, and a resin material layer by curing a coated resin on the main surface of a glass substrate; a step of forming a display circuit configured by a plurality of lamination material layers, on the main surface side of the resin material layer; and a step of exfoliating at the interface between the resin material layer and the electric conductive film, by irradiating a light or a laser from the surface on the opposite side to the surface provided with the display circuit of the glass substrate, thereby using the resin material layer, from which the glass substrate provided with the electric conductive film is removed, as a substrate provided with the display circuit.

(10) A method of manufacturing a display device according to the present invention is characterized in that, for example, on the premise of a configuration of (9), the electric conductive film is composed of a laminated layer of any of ZnO, SnO, WOₓ, MoOₓ, GeOₓ, Ge and SiGe, or a combination thereof.

It should be noted that the present invention is not limited to the above configurations, and various modifications are possible within a range not to depart from technical concept of the present invention.

A method of manufacturing a display device configured in this way enables to provide manufacturing in low cost by a simple configuration. In addition, a method of manufacturing a display device configured in this way makes it possible to manufacture by application of an existing manufacturing line as it is.

Other objects, features and advantages of the invention will become apparent from the following description of the embodiments of the invention taken in conjunction with the accompanying drawings.

### BRIEF DESCRIPTION OF THE DRAWINGS

FIGS. 1A to 1E are process charts showing an embodiment of a method of manufacturing of a display device according to the present invention.

FIG. 2A is a plan view showing one embodiment of a liquid crystalline display device as a target of a method of manufacturing according to the present invention.

FIG. 2B is a cross-sectional view showing one embodiment of a liquid crystalline display device as a target of a method of manufacturing according to the present invention.

FIG. 3 is a cross-sectional view showing one embodiment of a liquid crystalline display device as a target of a method of manufacturing according to the present invention.

FIG. 4A is a plan view showing other embodiment of a liquid crystalline display device as a target of a method of manufacturing according to the present invention.

FIG. 4B is a cross-sectional view showing other embodiment of a liquid crystalline display device as a target of a method of manufacturing according to the present invention.

FIG. 5A is a plan view showing other embodiment of a liquid crystalline display device as a target of a method of manufacturing according to the present invention.

FIG. 5B is a cross-sectional view showing other embodiment of a liquid crystalline display device as a target of a method of manufacturing according to the present invention.

FIGS. 6A to 6F are process charts showing other embodiment of a method of manufacturing of a display device according to the present invention.

FIGS. 7A to 7F are process charts showing other embodiment of a method of manufacturing of a display device according to the present invention.

FIG. 8 is a cross-sectional view showing one embodiment of an organic EL display device which can be a target of a method of manufacturing according to the present invention.

FIGS. 9 to 13 are illustrations showing application examples of a display device as a target of a method of manufacturing according to the present invention.

### DETAILED DESCRIPTION OF THE EMBODIMENTS

Explanation will be given below on embodiments of a method of manufacturing a display device according to the present invention, with reference to drawings.

### Embodiment 1

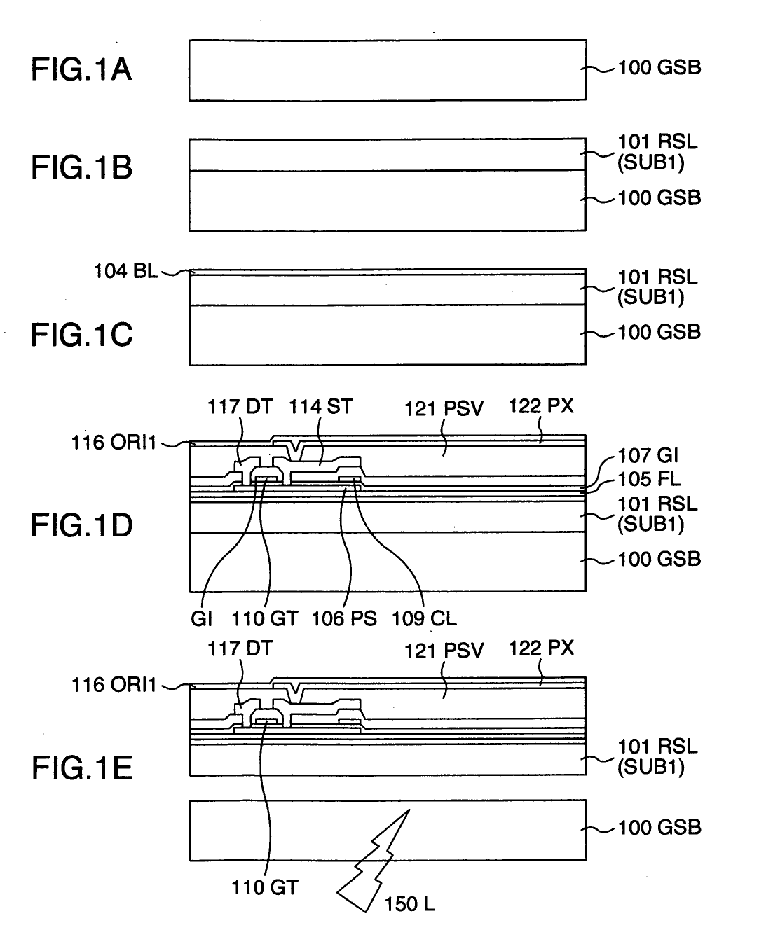

FIGS. 1A to 1E are process charts showing an embodiment of a method of manufacturing of a display device according to the present invention. A display device in this Embodiment is directed to an active-matrix type liquid crystal display device, and FIGS. 1A to 1E show a manufacturing method of a substrate SUB1 on the side provided with a thin film transistor at each pixel, among a pair of substrates, SUB1 101 and SUB2 131, which are arranged in an opposing manner via a liquid crystal.

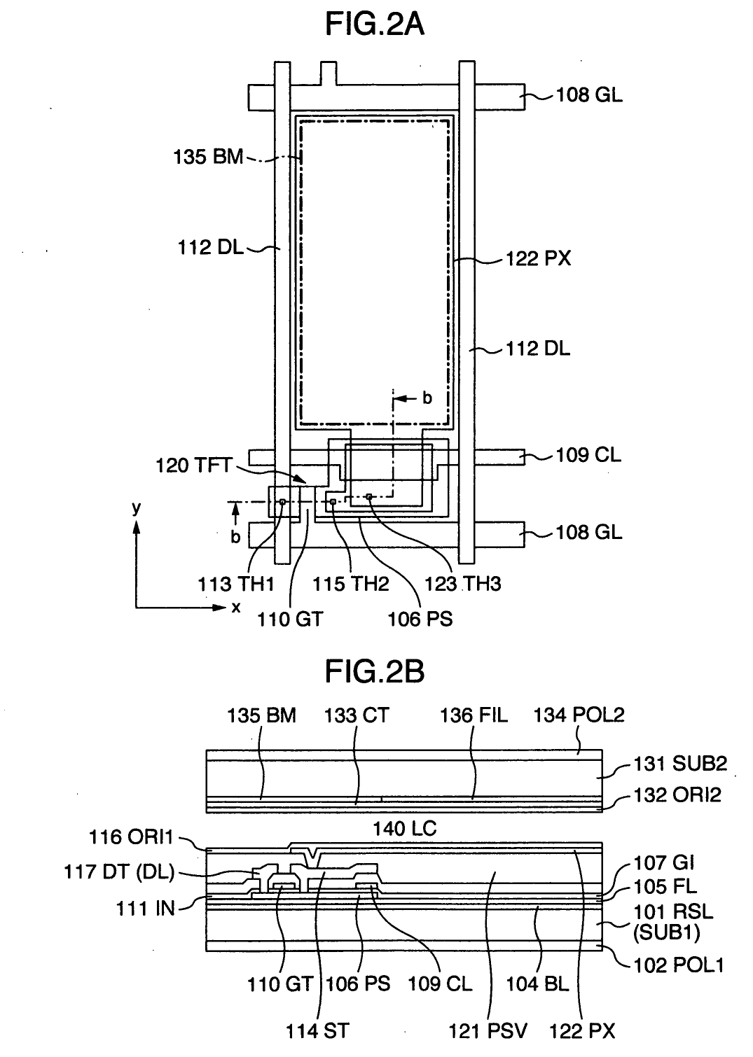

Explanation will be given first briefly on the configurations of the above display devices, with reference to FIGS. 2A and 2B, before explanation on a manufacturing method shown in FIGS. 1A to 1E.

FIG. 2A is a plan view showing one pixel among each pixels of the liquid crystal display device, arranged in a matrix manner. In addition, FIG. 2B shows a cross-sectional view along a b-b line of FIG. 2A, and also shows a substrate SUB2 131, as well as the substrate SUB1 101.

First, transparent substrates SUB1 101 and SUB2 131 are arranged in an opposing manner, via a liquid crystal LC 203. The substrate SUB1 101 is composed of a resin material RSL, and the substrate SUB2 131 is composed of a glass material or a resin material.

As the resin material RSL composing the substrate SUB1 101, there is used a polymer material having a molecular structure of a thermally or chemically stable imide ring (a hetero cycle) or an aromatic ring or the like, for example, like polyimide or the like.

On the surface on a liquid crystal LC 140 side of the substrate SUB1 101, first, a barrier layer BL 104 and a base layer FL 105 are formed sequentially. The barrier layer BL 104 is designed so as to avoid intrusion of water or oxygen from the substrate SUB1 101, and is composed of a laminated layer of any of a silicon oxynitride film (SiON), a silicon oxide film (SiO₂), a silicon nitride film (SiONₓ), a polysilazane film, an organic material film and SOG, or a combination thereof. These materials are designed to be formed by a sputtering method, a CVD method, an ion plating method at 300° C., a coating method or the like.

In addition, on the surface of the foundation layer FL 105 formed by, for example, a silicon oxide film (SiO₂) and a silicon nitride film (SiNₓ) or the like, there is formed a semiconductor layer PS 106 composed of, for example, polysilicon. The base layer FL 105 may not be present in the case where the barrier layer BL 104 plays that role. This semiconductor layer PS 106 becomes a semiconductor layer of a thin film transistor TFT 120, to be described later, and is formed in an island form at a pixel, along with at a part of the peripheral of the pixel. It should be noted that the polysilicon is designed to crystallize by irradiation of laser light onto amorphous silicon.

On the surface of the substrate SUB1 101 provided with said semiconductor layer PS 106, an insulating layer GI 107, composed of, for example, a silicon oxide film (SiO₂) or the like, is formed so as to cover also the semiconductor layer PS 106. This insulating layer GI 107 is designed to function as a gate insulating film of the thin film transistor TFT, in a formation region of the thin film transistor TFT.

On the surface of the insulating layer GI 107, a gate signal line GL 108 is formed, and a part of the gate signal line GL 108 is designed to extend so as to stride over a part of the semiconductor layer PS 106, and to configure a gate electrode GT 110 of the thin film transistor TFT 120. It should be noted that the gate signal line GL 108 is designed to be formed lining the display part, for example, in a horizontal direction (the x direction in the drawing), and positioned on one side defining a region of said pixel.

In addition, a capacitance signal line 109 is designed to be formed simultaneously at forming, for example, the gate electrode GT 110.

On the surface of the substrate SUB1 101 provided with the gate signal line GL 108 and the gate electrode GT 110, an insulating film IN 111 composed of, for example, a silicon oxide film (SiO₂), is formed so as to cover also these gate signal line GL 108 and gate electrode GT 110. This insulating film IN 111, together with the insulating layer GI 107, has a function as an interlayer insulating film of a drain signal line 112 to be described later against the gate signal line GL 108.

On the surface of the insulating film IN 111, the drain signal line 112 is formed, extending in a direction crossing with the gate signal line GL 108 (the y direction in the drawing). A part of this drain signal line 112 is connected to a region (a drain region) at one side relative to a region (a channel region) superimposed with the gate electrode GT 110 of the semiconductor layer PS 106 as a drain electrode DT 117 of the thin film transistor TFT 120, via a through-hole TH1 113 formed in the insulating films IN 111 and GI 107.

In addition, a source electrode ST 114 of the thin film transistor TFT 120 is formed simultaneously at forming the drain signal line 112, and this source electrode ST 114 is connected to a region (a source region) on the other side relative to a region (a channel region) superimposed with the gate electrode GT 110 of the semiconductor layer PS 106, via a through-hole TH2 115 formed in the insulating films IN 111 and GI 107. This source electrode ST 114 is designed to be connected with the pixel electrode PX 122 to be described later, and the connection part is formed with the relatively wide area.

It should be noted that, in the thin film transistor TFT 120, the drain and the source thereof are exchanged according to a bias application state, however, for explanation convenience, in the present specification, a side connected to the drain signal line 112 is referred to as the drain electrode DT 117, and a side connected to a pixel electrode PX 122 is referred to as a source electrode ST 114.

On the surface of the substrate SUB1 101 provided with the drain signal line 112, the drain electrode DT 117 and the source electrode ST 114, a protection film PSV 121 composed of, for example, a resin material, is formed so as to cover also these drain signal line 112, drain electrode DT 117 and source electrode ST 114. The protection film PSV 121 has a function to avoid the direct contact of the thin film transistor TFT 120 with a liquid crystal. The reason for using a resin material as the material thereof is to flatten the surface. The protection film PSV 121 may be configured by a two-layer structure of a silicon nitride layer (SiNₓ) and a resin film.

On the surface of the protection film PSV 121, a pixel electrode PX 122 composed of, for example, ITO (Indium Tin Oxide), is formed, and this pixel electrode PX 122 is connected to the source electrode ST 114 of the thin film transistor TFT 120, via a through-hole TH3 123 formed on the protection film PSV 121. This pixel electrode PX 122 is formed over the most part of a region of said pixel, and is designed to generate a electric field via a liquid crystal LC 140 between itself and a counter electrode CT 133 formed on a substrate SUB2 131 side to be described later.

Further, on the surface of the substrate SUB1 101 provided with the pixel electrode PX 122, an oriented film ORI1 116 is formed. This oriented film ORI1 116 contacts directly with a liquid crystal LC 140 and is designed to determine an initial orientation direction of a molecule of a liquid crystal LC 140, together with an oriented film ORI2 132 on the substrate SUB2 131 side to be described later.

In addition, on the surface of the opposite side to the liquid crystal LC 140 of the substrate SUB1 101, a polarizing plate POL1 102 is formed. This polarizing plate POL1 102 is designed to have a function to visualize a behavior of the liquid crystal LC 140, together with a polarizing plate POL2 134 on the substrate SUB2 131 side to be described later.

The substrate SUB2 131 is present facing to the substrate SUB1 101 via the liquid crystal LC 140, and on the surface of the liquid crystal side of this substrate SUB2 131, a black matrix BM 135 is formed. This black matrix BM 135 is formed by having an opening at the center part excluding, for example, the peripheral of the pixel, and in the opening a color filter FIL 136 is formed. It should be noted that the opening of the substrate SUB2 131 is shown by a dashed line frame in FIG. 2A. On the surface of the substrate SUB2 131 provided with the substrate SUB2 131 and the color filter FIL 136, a counter electrode CT 133 composed of, for example, ITO (Indium Tin Oxide) is formed so as to cover also these black matrix BM 135 and color filter FIL 136. This counter electrode CT 133 is formed as common use for each pixel, and is designed to be supplied with a signal composed of reference potential for an image signal to be supplied to the pixel electrode PX 122.

On the surface of the substrate SUB2 131 provided with the counter electrode CT 133, an oriented film ORI2 132 is formed, and on the surface of the opposite side to the liquid crystal LC 140 of the substrate SUB2 131, a polarizing plate POL2 134 is formed.

In a pixel having such a configuration, by supplying a scanning signal composed of, for example, “High” level to the gate signal line GL 108, each thin film transistor TFT 120 of a pixel row containing the the pixel is set “ON”, and the image signal is designed to be supplied to the pixel electrode PX 122 from the drain signal line 112 of each pixel, through the thin film transistor TFT 120 set “ON”. To the counter electrode CT 133 on the substrate SUB2 131 side, the reference signal is supplied, so that light transmittance based on behavior of a molecule of the liquid crystal LC 140 is varied corresponding to potential difference between the image signal and the reference signal.

FIGS. 1A to 1E show process charts in the case of manufacturing a configuration of a surface on a liquid crystal side of the substrate SUB1 101 by using the substrate SUB1 101 composed of the resin material RSL, and shows a part formed with the thin film transistor TFT 120. Explanation will be given below in the order of the steps.

First, as shown in FIG. 1A, a glass substrate GSB 100 is provided. This glass substrate GSB 100 is one having a function to hold the substrate SUB1 101 having flexibility, in a manufacturing process of a display device, and after the function is ended, it is designed to be removed. From this view point, the glass substrate GSB 100 may be optional in thickness thereof or the like, as long as it is mechanically strong.

Then, as shown in FIG. 1B, by curing a resin material by using light or heat after coating thereof on the surface of the glass substrate GSB 100, the resin material layer RSL 101 is formed, which will be configured as the substrate SUB1 101 later. Accordingly, the layer thickness of the resin material layer 101 is set corresponding to the thickness of the substrate SUB1 101 to be obtained.

As a material of the resin material layer, there is used a polymer material, having a molecular structure of a thermally or chemically stable imide ring (a hetero cycle) or an aromatic ring etc., for example, such as polyimide etc., in the main chain. This resin material layer has light transmittance of equal to or higher than 70% for light having a wavelength of from 400 nm to 800 nm. Furthermore, transmittance for a wavelength of equal to or less than 300 nm is equal to or lower than 70%. In addition, the heat resistance temperature of the resin material layer is equal to or higher than 200° C.

Then, as shown in FIG. 1C, on the surface of the resin material layer, the barrier layer BL 104 is formed, for example, by a laminated layer of any of a silicon oxynitride film (SiON), a silicon oxide film (SiO₂), a silicon nitride film (SiONₓ), a polysilazane film, SOG and an organic material film, or a combination thereof. The barrier layer BL 104 is formed to avoid intrusion of water or oxygen from the resin material layer by using, for example, a sputtering method, a vapor deposition method, or a CVD method, or the like.

Then, as shown in FIG. 1D, a display circuit configured by a plurality of lamination material layers is formed on the barrier layer BL 104. In this Embodiment, the display circuit is configured comprising the thin film transistor TFT, and for example, one is configured by sequential lamination of, the foundation layer FL 105, the semiconductor layer PS 106, the insulating layer GI 107, the gate signal line GL 108 and the gate electrode GT 110 and the capacitance signal line 109, the insulating film IN 111, the drain signal line 112 and the drain electrode DT 117 and the source electrode ST 114, the protection film PSV 121, the pixel electrode PX 122, and the oriented film ORI1 116.

However, in this specification, there are following cases, in which the pixel drive element or a display circuit is understood as: a concept containing also the oriented films ORI1 116 and ORI2 132, the polarizing plate POL1 102, the polarizing plate POL2 134 and the like, and composed of a material layer formed on the substrate SUB1 101 or the substrate SUB2 131, which contributes to image display; or a part of a material layer such as a material layer required to form, for example, a thin film transistor TFT among these material layers.

A manufacturing of the display circuit in this case results in exerting an advantageous effect that an existing manufacturing line is applicable as it is, because a lamination material layer with a plurality of patterns is formed on the surface of the glass substrate GSB 100 in a similar way to the conventional manner, even when it is configured, for example, via the substrate SUB1 101 and the barrier layer BL 104.

Then, as shown in FIG. 1E, light L 150 of lamp light having ultraviolet wavelength or laser light is irradiated from the opposite side to a liquid crystal side of the glass substrate GSB 100. As the light L 150, wavelength thereof is in a range of from about 200 nm to about 500 nm, is used. The reason for setting the wavelength equal to or longer than about 200 nm is that it is the wavelength transmittable through the glass substrate GSB 100, and the reason for setting the wavelength equal to or shorter than about 500 nm is that it is the wavelength absorbable by the substrate SUB1 101.

The substrate SUB1 101 irradiated by light having such wavelength is subjected to ablation at the interface with the glass substrate GSB 100, and it becomes possible to make the glass substrate GSB 100 separated.

The resin material layer RSL 101, from which the glass substrate GSB 100 is removed in this way, is used as the substrate SUB1 101 to be provided with the display circuit in the handling hereafter, and is designed to function as a part of configuration parts of the display device, as shown in FIGS. 2A and 2B.

As described above, according to the method of manufacturing of a display device by the present invention, low cost manufacturing becomes possible by a simple configuration, because of no requirement of passing through complicated steps. In addition, it makes it possible to manufacture by applying an existing manufacturing line.

It should be noted that because the substrate SUB1 101 of the display device configured in this way is formed without passing through a plurality of conventional transfer steps, it is designed to have configuration features that an adhesion layer is not intervened between the resin material layer RSL 107 and the display circuit (in FIGS. 1A to 1E, a laminated layer having a barrier layer BL as the lowest layer).

The above method of manufacturing shows the case where the substrate SUB1 101 is formed as the resin material layer RSL. However, it is natural that the substrate SUB2 131 is also applicable in a similar way to a case of forming it by a resin material.

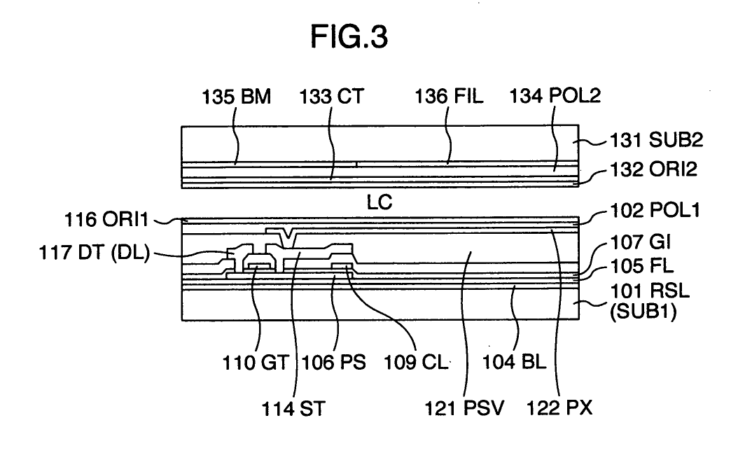

A liquid crystalline display device, which is a target of the above method of manufacturing, is provided-with the polarizing plate POLL 102 on the opposite side surface to a liquid crystal side of the substrate SUB1 101 composed of the resin material layer RSL, and is provided with the polarizing plate POL2 134 on the opposite side surface to a liquid crystal side of the substrate SUB2 131. However, as shown in FIG. 3, it may be directed to another one provided with the polarizing plate POL1 102 on the surface of the liquid crystal side of the substrate SUB1 101, and provided with the polarizing plate POL1 102 on the surface of the liquid crystal side of the substrate SUB2 131.

In FIG. 3, a configuration is shown where the polarizing plate POL1 102 is arranged, for example, between the pixel electrode PX 122 and the oriented film ORI1 116, and the polarizing plate POL2 134 is arranged, for example, between the color filter FIL 136 and the counter electrode CT 133. However, it is not limited to this arrangement.

By composing the substrate SUB1 101 with the resin material layer RSL, it can be designed to exert an advantageous effect of enhancing optical characteristics as a display device, by forming the polarizing plate POL1 102 on the surface of the liquid crystal side of the substrate SUB1 101, even when birefringence of the resin material layer RSL thereof becomes high. This is similar also in the substrate SUB2 131.

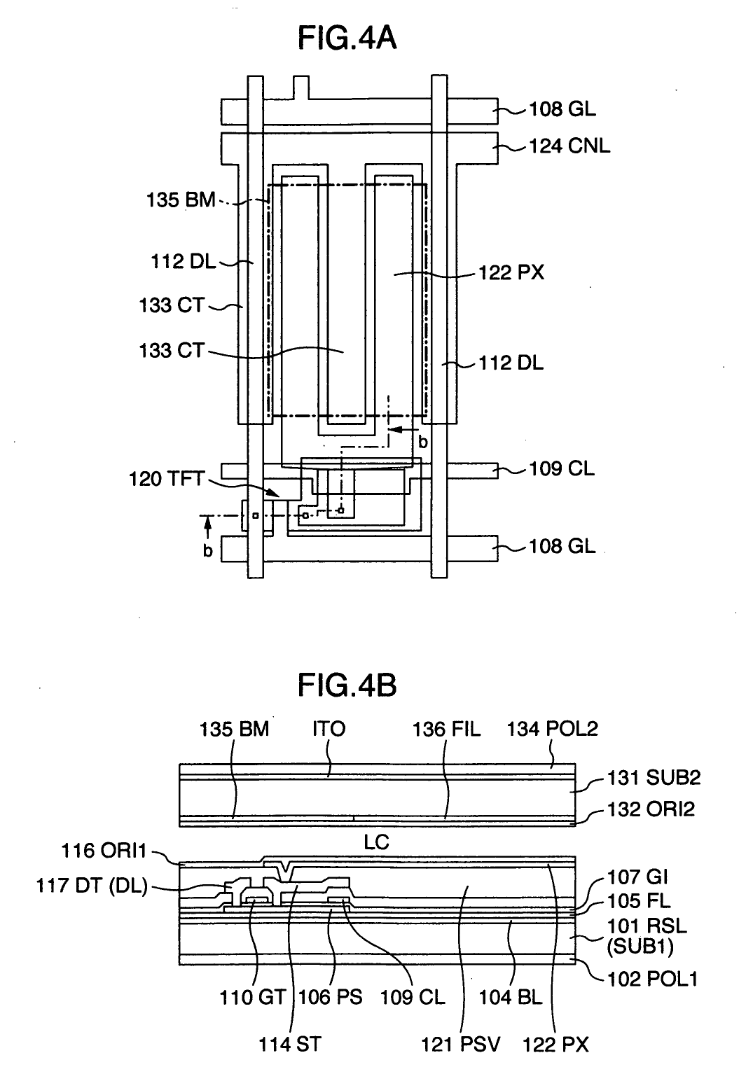

The above Embodiment of method of manufacturing is directed to a liquid crystal display device called, for example, a TN, VA or ECB system. However, the present invention is applicable also, for example, to a liquid crystal display device called an IPS system, as shown in FIGS. 4A and 4B.

FIGS. 4A and 4B are plan and cross-sectional views drawn corresponding to FIGS. 2A and 2B, where the same reference numerals as in FIGS. 2A and 2B represent the same material and configuration.

Configuration difference, as compared with FIGS. 2A and 2B, is that the counter electrode CT 133, as well as the pixel electrode PX 122, is formed on the surface of the liquid crystal side of the substrate SUB1 101, for example, by the same layer. Therefore, it provides a configuration where the counter electrode CT 133 is not formed on the surface of the liquid crystal side of the substrate SUB2 131. However, in order to reduce noise from outside, it is desirable to form a transparent electric conductive film ITO on the surface of the substrate SUB2 131.

Both of the pixel electrode PX 122 and the counter electrode CT 133 are configured by a comb-teeth-like electrode, and they are arranged so as to be engaged with some amount of clearance.

A reference signal being a standard against an image signal is designed to be supplied to the counter electrode CT 133 via a common signal line CNL 124, and in a similar way to in FIGS. 2A and 2B, the image signal is designed to be supplied to the pixel electrode PX 122 from the drain signal line 112 via the thin film transistor TFT 120.

In this way, electric field containing an electric field component parallel to the surface of the substrate SUB1 101 is generated between the pixel electrode PX 122 and the counter electrode CT 133, and a molecule of the liquid crystal LC 140 is designed to move by this electric field.

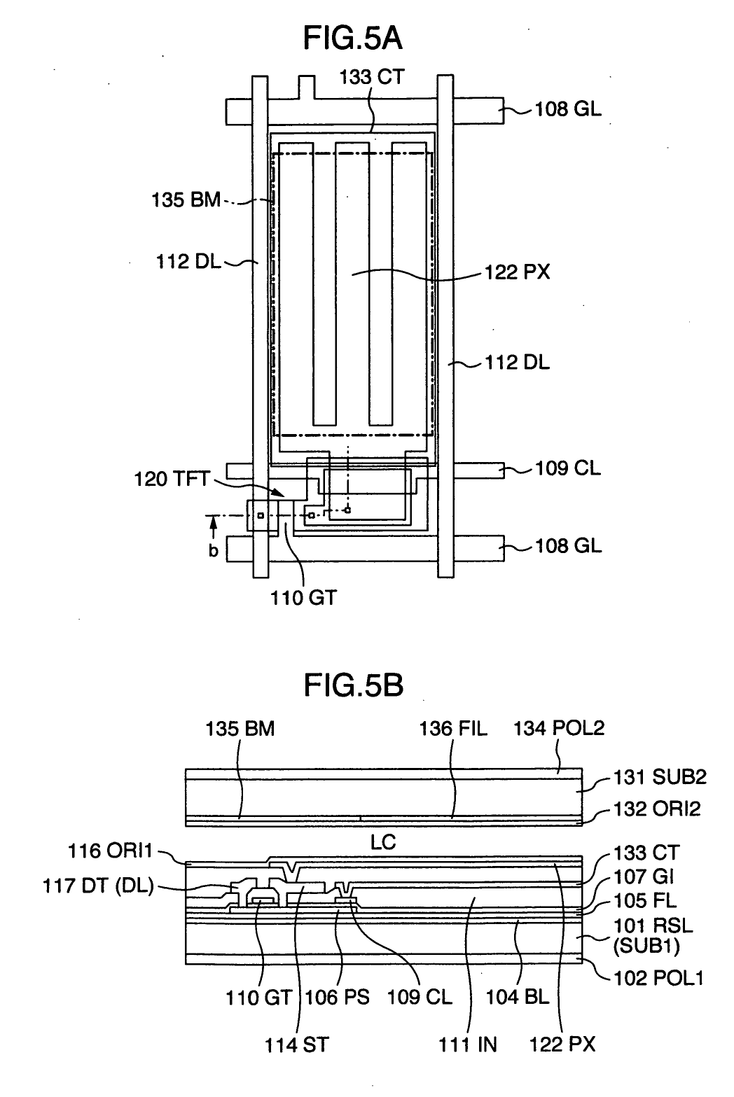

In addition, FIGS. 5A and 5B show a liquid crystal display device called an IPS-Pro system, and the present invention is applicable also to such a liquid crystal display device.

FIGS. 5A and 5B are plan and cross-sectional views drawn corresponding to FIGS. 4A and 4B, where the same reference numerals as in FIGS. 4A and 4B represent the same material and configuration.

A configuration difference as compared with FIGS. 4A and 4B is that, firstly, the counter electrode CT 133 and the pixel electrode PX 122 are formed at different layers via the insulating film IN 111.

The counter electrode CT 133 is composed of, for example, an ITO film, and is formed at the most part of a pixel region, and also a part thereof is connected to the capacitance signal line 109 via a through-hole formed on the insulating film intervened between itself and the capacitance signal line 109. In this way, the counter electrode CT 133 is designed to be supplied with the reference signal being a standard against the image signal, via the drain signal line 112.

In addition, the pixel electrode PX is designed to be supplied with the image signal from the drain signal line 112 via the thin film transistor TFT, in a similar way to the case of FIGS. 4A and 4B.

Further, the pixel electrode PX 122 is arranged so as to be superimposed on the counter electrode CT 133, and is formed in a comb-teeth-like pattern. As electric field generated between the pixel electrode PX 122 and the counter electrode CT 133, it is designed so that electric field called so-called “fringe electric field” may be generated between the counter electrode CT 133 on the end side of the pixel electrode PX 122, and may move a molecule of a liquid crystal, besides the electric field shown in FIGS. 4A and 4B.

The pixel electrode PX 122 may be composed of a non-translucent material, without limiting to a translucent material.

### Embodiment 2

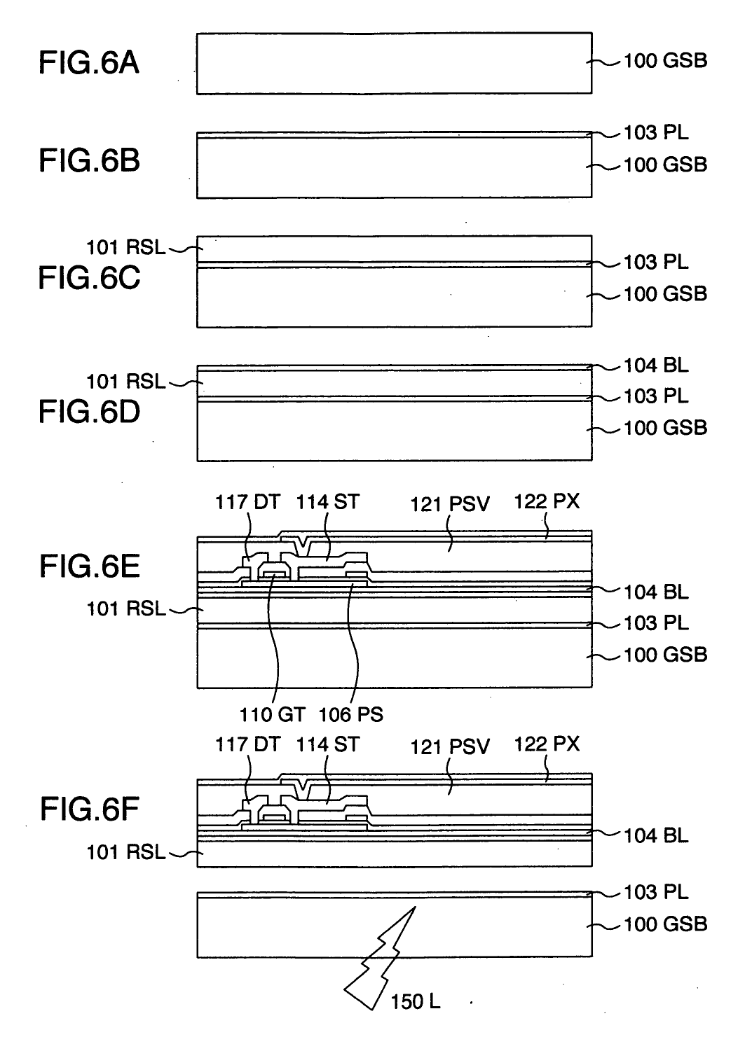

FIGS. 6A to 6F are process charts showing other embodiment of a method of manufacturing of a display device according to the present invention, and are drawn corresponding to FIGS. 1A to 1E.

A configuration difference, as compared with FIGS. 1A to 1E, is that, in FIGS. 1A to 1E, the resin material layer RSL 101 to be configured as the substrate SUB1 101 is directly formed on the surface of the glass substrate GSB 100, while in the case of FIGS. 6A to 6E, the resin material layer RSL 101 is formed via an exfoliating layer PL 103. That is, as shown in FIG. 6B, the exfoliating layer PL 103 is designed to be formed on the main surface of the glass substrate GSB, and then, as shown in FIG. 6C, the resin material layer RSL is designed to be formed on the upper surface of the exfoliating layer PL 103.

The exfoliating layer PL 103 is composed of a resin film, for example, a polyimide film or the like, and separation of the glass substrate GSB 100 from the resin material layer RSL 101 is designed to carry out by exfoliating at the interface between the resin material layer RSL 101 and the exfoliating layer PL 103, or in the exfoliating layer PL 103, as shown in FIG. 6F.

Therefore, a material of the exfoliating layer PL 103 can be selected from a view point of exfoliating easily from the resin material layer RSL 101 by light irradiation. The exfoliating becomes easier in the case where the resin material layer RSL 101 has higher transmittance for light with a wavelength of equal to or shorter than 500 nm as compared with the exfoliating layer PL 103.

Further, by selecting the material of the exfoliating layer PL 103 exfoliating easily from the resin material layer RSL 101 in this way, the advantageous effect is exerted that a suitable material of the resin material layer RSL 101 can be selected in a wide range. That is, in the case of FIGS. 1A to 1E, there can be solved a drawback that selection of a suitable material of the resin material layer RSL 101 which can be exfoliated from the glass substrate GSB 100 is limited.

It should be noted that, as shown in FIG. 6F, in the case where the glass substrate GSB 100 is separated from the resin material layer RSL 101, the exfoliating layer PL 100 is deposited on the glass substrate GSB 100 side, and the substrate SUB1 101 (provided with a display circuit) obtained in this Embodiment takes nearly the same configuration as in the substrate SUB1 101 (provided with a display circuit) obtained in Embodiment 1.

### Embodiment 3

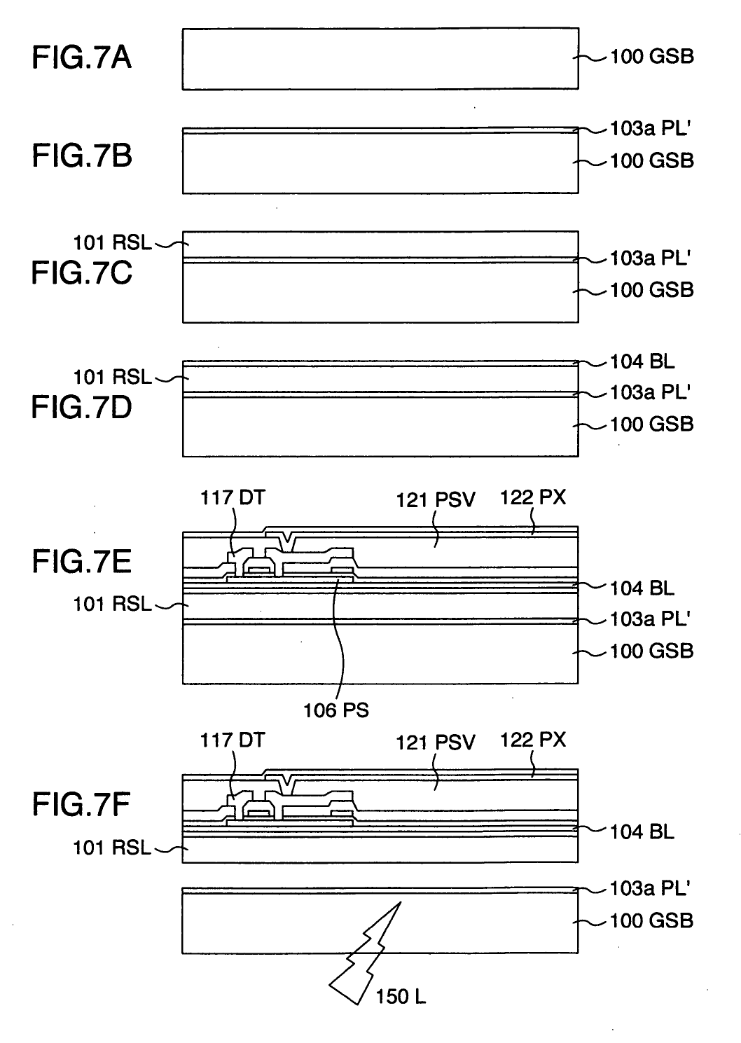

FIGS. 7A to 7E are process charts showing other embodiment of a method of manufacturing of a display device according to the present invention, and are drawn corresponding to FIGS. 6A to 6F.

A configuration difference, as compared with FIGS. 6A to 6F, is the material difference of the exfoliating layer PL′ 103 to be intervened between the glass substrate GSB 100 and the resin material layer RSL 101. The exfoliating layer PL 103a in FIGS. 6A to 6F is composed of a resin film such as a polyimide film or the like, while in the case of FIGS. 7A to 7E, it is composed of a laminated layer of any of ZnO, SnO, WOₓ, MoOₓ, GeOₓ, Ge and SiGe, or a combination thereof.

The exfoliating layer PL′ 103a, composed of these ZnO, SnO, WOₓ, MoOₓ, GeOₓ, Ge, SiGe and the like, can be formed as a film having high electric conductivity in any case. Therefore, in each of the steps to form the display circuit, the exfoliating layer PL′ 103a functions as a shielding material against static electricity, and exerts an advantageous effect that yield reduction caused by static electricity can be significantly suppressed.

In any of the methods of manufacturing of Embodiment 1 to Embodiment 3, after forming a display circuit configured by a plurality of lamination material layers on the main surface side of the resin material layer RSL 101, the glass substrate GSB 100 fixed to the resin material layer RSL 101 is exfoliated. However, the exfoliation of the glass substrate GSB 100 from the resin material layer RSL 101 may be carried out, for example, after completing the thin film transistor TFT 120 among the display circuits. In addition, the exfoliation of the glass substrate GSB 100 may be carried out, after fixing the substrate SUB2 131 to the substrate SUB1 101 contacted with the glass substrate GSB 100. Furthermore, the exfoliation of the glass substrate GSB 100 may be carried out in a module state after encapsulating liquid crystal.

### <Application Examples to Other Display Devices>

In the above Embodiment, explanation was given on the present invention with reference to a liquid crystal display device as an example. However, without being limited thereto, the present invention is applicable also to other display devices such as an organic EL (Electro luminescence) display device.

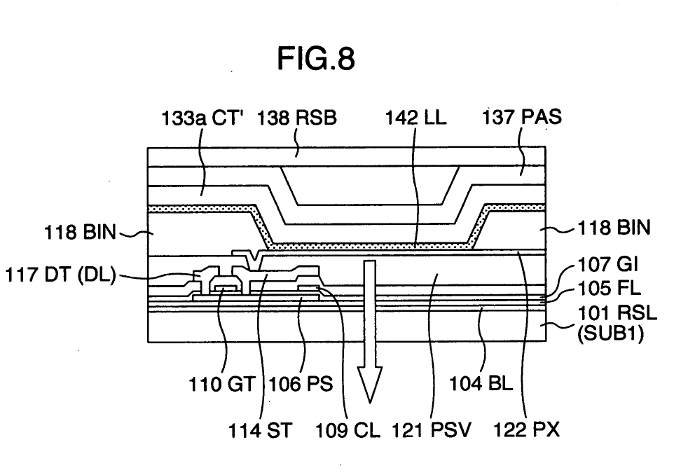

A pixel of the organic EL display device has, for example, as shown in FIG. 8, a self-luminescent organic EL layer LL 142, and this organic EL layer LL 142 is arranged by being sandwiched between the pixel electrode PX 122 and the counter electrode CT 133, and is configured so as to give luminescence induced by electric current supplied from one of these electrodes to the other electrode.

In the case of driving each of the pixels arranged in a matrix manner, in a similar way to in a liquid crystal display device, it is configured so that each pixel is provided with the thin film transistor TFT 120, and it is designed that the image signal (electric current) is supplied to the pixel electrode PX 122 from the drain signal line 112 via the thin film transistor TFT.

Accordingly, a pixel configuration of the organic EL display device is that, as shown in FIG. 8, a bank insulation film BIN 118, the organic EL layer LL 142, the upper part electrode CT′ 133a, the protection film PAS 137 and the resin substrate RSB 138 are sequentially laminated on the upper surface of the display circuit provided with the pixel electrode PX 122 at the most upper layer and formed on the substrate SUB1 101. In addition, it is usual that the display circuit of the organic EL display device is provided with at least one thin film transistor for electric current control, in addition to the above-described display circuit.

Here, the bank insulation film BIN 118 is configured by an insulating film composed of, for example, SiN provided with a hole at a part to substantially become a pixel region, and the pixel electrode PX 122 is exposed to the hole so that a liquid organic EL material can be filled sufficiently. In addition, the upper part electrode CT′ 133a is designed to become an electrode for the reference signal (electric current) to be applied, being a standard against the image signal.

It should be noted that, in a configuration shown in FIG. 8, by composing the upper part electrode CT′ 133a, for example, with Al, and the pixel electrode PX 122, for example, with an ITO film, light (shown by an arrow mark in the drawing) from a luminescent layer layer LL 142 is introduced by transmitting through the substrate SUB1 101.

In an organic EL display device having such a configuration, the substrate SUB1 101 can be composed of the resin material layer RSL, and in the manufacture thereof the above-described method of manufacturing can be applied as it is.

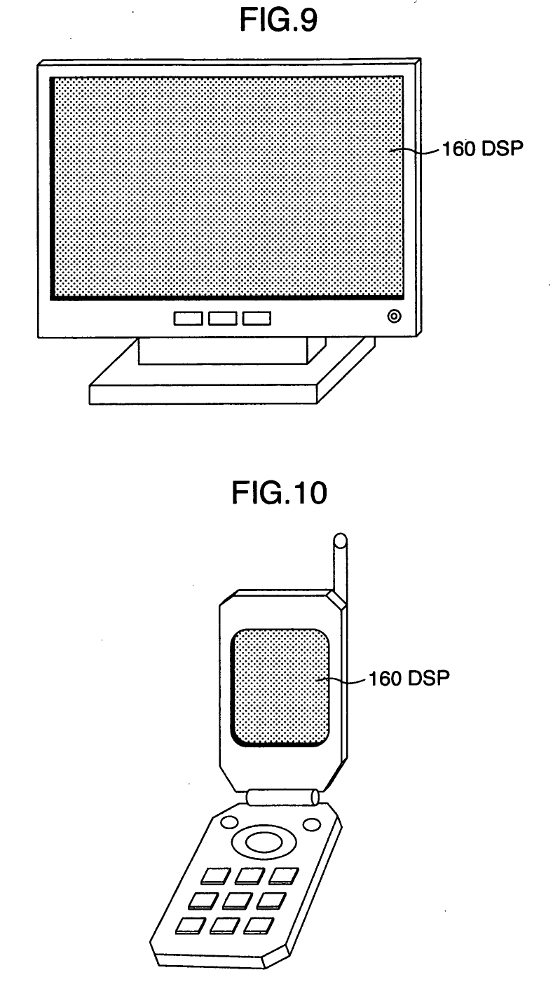

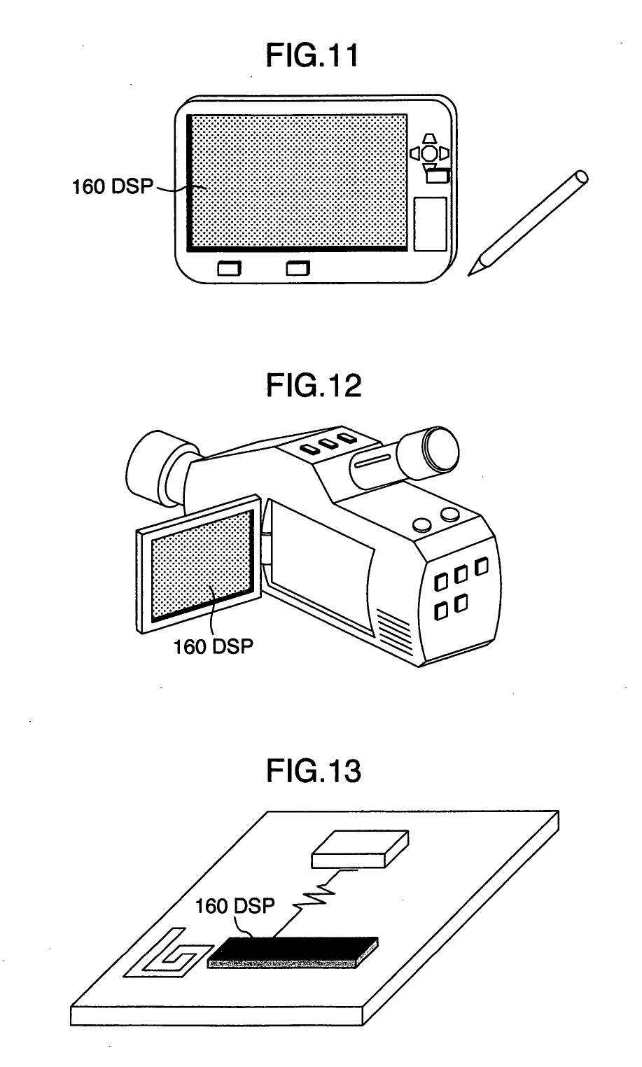

As described above, a display device wherein a resin material is used as a substrate can be used as a display device DSP 160 of a personal computer as shown in FIG. 9, and as a display device DSP 160 of a mobile-phone as shown in FIG. 10. In addition, it can be used also as a display device DSP 160 of a mobile game machine as shown in FIG. 11, a display device DSP 160 of a video camera as shown in FIG. 12, and a display device DSP 160 of a card mounted with personal identification function or the like as shown in FIG. 13. Furthermore, although not shown, it can be used also as each display device of a mobile computer, an electronic book, a digital camera, or a head mount-type display.

The above-described each Embodiment may be used singly or by combination. It is because effect in each of the Embodiments can be exerted singly or in a synergistic manner.

In the above-described Embodiments, a resin material layer formed first was used singly as a substrate provided with a thin film transistor, however, other resin substrate may be laminated on the back surface of this substrate for reinforcement, after forming a display device. Furthermore, a substrate on a color filter side can be configured also as the resin substrate in a similar way to described above.

1. A method of manufacturing a display device characterized by comprising:
a step of forming a resin material layer by curing a resin coated on the main surface of a glass substrate;
a step of forming a-plurality of lamination material layers configuring a display circuit on the main surface side of said resin material layer; and
a step of generating exfoliation at the interface between said resin material layer and said glass substrate by irradiating light from the surface on the opposite side to the surface provided with said lamination material layer of said glass substrate,
thereby using said resin material layer, from which said glass substrate is removed, as a substrate provided with said display circuit.

2. The method of manufacturing the display device according to claim 1, characterized in that said resin material layer is composed of a material having an imide ring structure in the main chain.

3. The method of manufacturing the display device according to claim 1, characterized in that said display circuit, formed on the main surface side of said resin material layer, is formed with intervention of a barrier layer to avoid intrusion of water or oxygen from said resin material layer side.

4. The method of manufacturing the display device according to claim 3, characterized in that said barrier layer is composed of a laminated layer of any of a silicon oxynitride film, a silicon oxide film, a silicon nitride film, a polysilazane film and an organic material film, or a combination thereof.

5. The method of manufacturing the display device according to claim 1, characterized in that said display circuit is a circuit provided with a thin film transistor.

6. The method of manufacturing the display device according to claim 1, characterized in that a polarizing plate is provided as one of each lamination material layers configuring said display circuit.

7. A method of manufacturing a display device characterized by comprising:
a step of sequentially forming a first resin material layer and a second resin material layer, having larger light transmittance than that of said first resin material layer, by curing a resin coated on the main surface of a glass substrate;
a step of forming a display circuit configured by a plurality of lamination material layers on the main surface side of said second resin material layer; and
a step of generating exfoliation at the interface between said first resin material layer and said second resin material layer or in first resin material layer, by irradiating light from the surface on the opposite side to the surface provided with said display circuit of said glass substrate,
thereby using said second resin material layer, from which said glass substrate contacted with said first resin material layer is removed, as a substrate provided with said display circuit.

8. The method of manufacturing the display device according to claim 7, characterized in that at least either of said first resin material layer and the second resin material layer is composed of a material having an imide ring structure in the main chain.

9. A method of manufacturing a display device characterized by comprising:
a step of sequentially forming a resin material layer by curing an electric conductive film and a coated resin on the main surface of a glass substrate;
a step of forming a display circuit configured by a plurality of lamination material layers on the main surface side of said resin material layer; and
a step of generating exfoliation at the interface between said resin material layer and said electric conductive film, by irradiating light or laser from the surface on the opposite side to the surface provided with said display circuit of said glass substrate,
thereby using said resin material layer, from which said glass substrate deposited with said electric conductive film, is removed, as a substrate provided with said display circuit.

10. The method of manufacturing the display device according to claim 9, characterized in that said electric conductive film is composed of a laminated layer of any of ZnO, SnO, WOₓ, MoOₓ, GeOₓ, Ge and SiGe, or a combination thereof.
